(19) United States
(12) Patent Application Publication
(10) Pub. No.: US 2008/0002939 A1
(43) Pub. Date: Jan. 3, 2008

(54) RECORDING APPARATUS, RECORDING METHOD

(75) Inventor: Masataka MOTEKI, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/769,306

(22) Filed: Jun. 27, 2007

(30) Foreign Application Priority Data
Jun. 30, 2006 (JP) 2006-182095

(51) Int. Cl. H04N 5/91

(52) U.S. Cl. 386/46

(57) ABSTRACT

This recording apparatus for recording stream data to a storage medium, includes: a first area generator configured to generate a first record area for recording a first stream data on the storage medium; a second area generator configured to generate a second record area and a third record area on the storage medium for repeatedly overwriting a second stream data, the second stream data being provided as a reproduction object only for a predetermined period different from the first stream data; a management information managing unit configured to record a management information file having management information of the first stream data recorded to the first record area and management information of the second stream data recorded to the second and third record areas to the storage medium; a recording unit for recording the second stream data to the second record area, stopping the record of the second stream data to the second record area based on a save instruction of the second stream data, and restarting the record of the second stream data to the third record area; a management information editor for updating the management information of the second stream data to the management information file as a stream data which is not to be overwrite recorded when the recording unit stops the record of the second stream data to the second record area; and an area transfer unit for transferring the second stream data corresponding to the updated management information from the second record area to the first record area when the management information editor updates the management information of the second stream data to the management information file.

### CROSS-REFERENCE TO THE APPLICATION

This application is based upon and claims the benefit of priority from the prior Japanese Patent Application No. 2006-182095, filed on Jun. 30, 2006; the entire contents of which are incorporated herein by reference.

### BACKGROUND

1. Field of the Invention

The present invention relates to a recording apparatus, a recording method recording a data such as, for example, a hard disk video recording device.

2. Description of the Related Art

A recording method so-called a loop recording is developed in a video recording apparatus and so on using a mass storage medium such as a hard disk. The loop recording is a recording system in which a fixed area is prepared in addition to an area for a normal recording, and an overwrite recording is repeated within the fixed area independent of the normal recording. The loop recording enables a recording without being conscious of remaining capacity of a storage medium though the record capacity is limited. Therefore, for example, it becomes possible to realize a usage in which a viewing program is temporary held when a user leaves in the middle of television viewing, and the viewing is restarted later subsequent to a position where the program is interrupted by the leaving. As a technology relating to the loop recording, the technology preparing an area to record audio data repeatedly is disclosed in JP-A 10-69300 (KOKAI).

In the loop recording, when the loop recording is started based on a user's operation and so on, the record to an area for the loop recording is started. When the record proceeds up to an end point of the area, subsequent record is continued by going back to a start point of the area. Accordingly, it is necessary to once stop the loop recording in order to save picture contents, and to perform an edit process for the saved picture contents to leave only necessary scenes for the user and to delete unnecessary scenes in the loop recording. This may cause the user to do complicated operations and it decreases the usability.

As stated above, there is a problem in the conventional recording apparatus and recording method that it is necessary to interrupt the loop recording and perform the edit process to save desired scenes from among the loop recorded picture contents.

### SUMMARY

The present invention is made to solve the above-stated problem, and an object thereof is to provide a recording apparatus, a recording method capable of saving desired picture contents without stopping a loop recording as much as possible.

To attain the above-stated object, a recording apparatus according to an aspect of the present invention, which records stream data to a storage medium, including: a first area generator configured to generate a first record area for recording a first stream data on the storage medium; a second area generator configured to generate a second record area and a third record area on the storage medium for repeatedly overwriting a second stream data, the second stream data being provided as a reproduction object only for a predetermined period different from the first stream data; a management information managing unit configured to record a management information file having management information of the first stream data recorded on the first record area and management information of the second stream data recorded on the second and third record areas to the storage medium; a recording unit for recording the second stream data to the second record area, stopping the record of the second stream data to the second record area based on a save instruction of the second stream data, and restarting the record of the second stream data to the third record area; a management information editor for updating the management information of the second stream data to the management information file as a stream data which is not to be overwrite recorded when the recording unit stops the record of the second stream data to the second record area; and an area transfer unit transferring the second stream data corresponding to the updated management information from the second record area to the first record area, when the management information editor updates the management information of the second stream data to the management information file.

A recording method according to an aspect of the present invention, including: recording data to a first record area of a storage medium, the data being provided as a reproduction object only for a predetermined period; continuing the record of the data from a start point of the first record area when the data is recorded up to an end point of the first record area; stopping the record of the data based on a save instruction for saving the recorded data; setting management information such that the recorded data is a data to be saved when the record of the data is stopped; and starting the record of the data to a second record area different from the first record area of the storage medium, when the management information is set.

### BRIEF DESCRIPTION OF THE DRAWINGS

FIG. 1 is a block diagram showing a configuration of a recording apparatus of a first embodiment according to the present invention.

FIG. 2 is a schematic view showing an overview of a data configuration in the recording apparatus of the first embodiment.

FIG. 3 is a block diagram showing a configuration of a record management information controller shown in FIG. 1.

FIG. 4 is a flow chart showing loop recording operations of the recording apparatus according to the first embodiment.

FIG. 5 is a schematic view showing recording operations of a normal recording in the first embodiment.

FIG. 6 is a schematic view showing the recording operations of the normal recording in the first embodiment.

FIG. 7 is a schematic view showing the recording operations of the normal recording in the first embodiment.

FIG. 8 is a schematic view showing recording operations of a loop recording in the first embodiment.

FIG. 9 is a schematic view showing the recording operations of the loop recording in the first embodiment.

FIG. 10 is a schematic view showing the recording operations of the loop recording in the first embodiment.

FIG. 11 is a schematic view showing the recording operations of the loop recording in the first embodiment.

FIG. 12 is a schematic view showing recording operations of a loop recording of a recording apparatus in a second embodiment; and

FIG. 13 is a schematic view showing recording operations of a loop recording of a recording apparatus in a third embodiment.

### DETAILED DESCRIPTION

In a video (recording apparatus), a television, and so on having so-called a loop recording function, it is possible for a user to perform a reproduction (playback) from a position where a television viewing is interrupted by performing a start-up operation of a loop recording when the user interrupts the television viewing for a while to leave in the middle or the like, and after that, by performing a start-up operation of a “chasing playback operation” and so on when the user restarts the television viewing.

Various styles are conceivable as for when to start and complete the loop recording, namely how long time the loop recording is performed, because they depend on how to use functions of the loop recording. For example,the loop recording is performed within a relatively limited period of time while the user is away, when the loop recording is used such that a viewing program is temporary held at the time when the user leaves during the television viewing, and the viewing is restarted later from a subsequent position where the program is interrupted by the user's leaving. On the other hand, for example, when the loop recording is used such that the loop recording is performed while the user is unaware of the loop recording by housing a recording apparatus within a television and activating the loop recording function automatically when a power of the television is turned on, the loop recording is performed for a relatively long time during the time while the power of the television is turned on.

In the latter case, the loop recording is performed for the relatively long time, and therefore, there is a case when not only necessary scenes for the user but also unnecessary scenes are mixed together within contents recorded by the loop recording. It is also the same in the former case, and there is a case when the necessary scenes and unnecessary scenes for the user are mixed together even if a time length of the contents is relatively short.

In order to leave only the necessary scenes and delete the unnecessary scenes for the user in the loop recording, the loop recording is once stopped to save picture contents, and an edit process is performed for the saved picture contents to thereby leave only the necessary scenes. Accordingly, complicated operations are required for the user, and usability thereof may not be good. Besides, the loop recording has to be once stopped to save and perform the edit process of the picture contents. Accordingly, for example, in the usage in which the loop recording is activated automatically when the power of the television is turned on, a convenience for the user significantly deteriorates because it is necessary to stop the loop recording for a certain degree of times for the edit process to leave the necessary scenes although it assumes that the loop recording is performed constantly while basically being unaware of the user.

In embodiments of the present invention described in the following, a recording apparatus capable of saving desired picture contents without stopping the loop recording as much as possible, is provided.

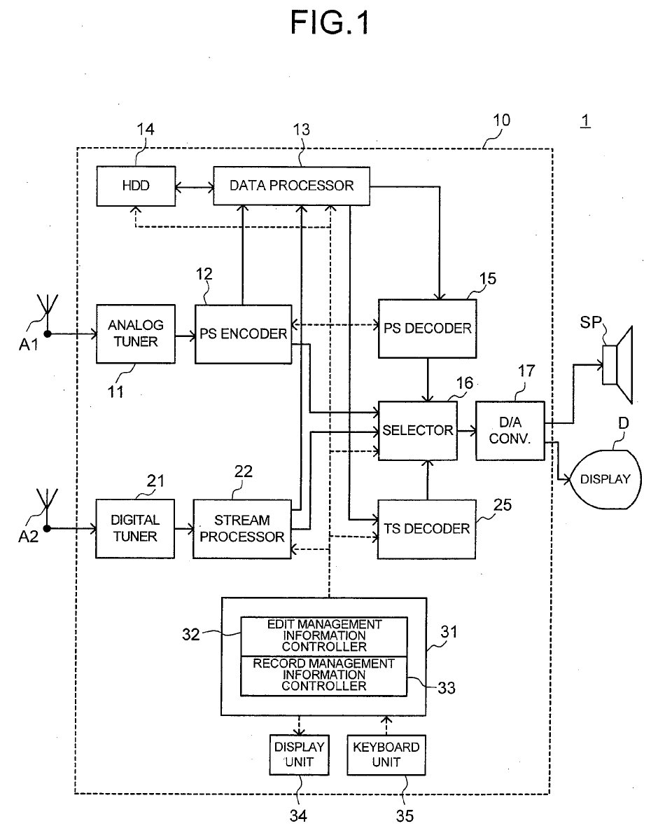

Hereinafter, the embodiments of the present invention are described in detail with reference to the drawings. FIG. 1 is a block diagram showing a configuration of a recording apparatus of a first embodiment according to the present invention.

As shown in FIG. 1, a recording apparatus 10 of this embodiment constitutes a TV system 1 together with a speaker SP, a display D, an analog antenna A1 receiving a terrestrial analog broadcast, and a digital antenna A2 receiving a digital broadcast.

The recording apparatus 10 of this embodiment includes an analog tuner 11, a PS encoder 12, a data processor 13, an HDD 14, a PS decoder 15, a selector 16, a D/A converter 17, a digital tuner 21, a stream processor 22, a TS decoder 25, a processor (CPU) 31 having an edit management information controller 32 and a record management information controller 33, a display unit 34, and a keyboard unit 35.

The analog tuner 11 receives an analog broadcast wave mainly broadcasted by a ground wave via the analog antenna A1. The analog tuner 11 performs a station selection/demodulation of the broadcast wave based on a predetermined broadcast system such as an NTSC, and the analog broadcast wave is converted into an analog picture signal and audio signal to be inputted to the PS encoder 12.

The PS encoder 12 is an encoder including an A/D converter digitalizing inputted analog video signal and analog audio signal, a video encoder, and an audio encoder, and it may include a sub-picture encoder. The PS encoder 12 converts the digitalized video signal into a compressed digital video signal with a variable bit rate based on a MPEG2 or MPEG1 standard. Besides, the PS encoder 12 converts the digitalized audio signal into a compressed digital audio signal with a fixed bit rate or a digital audio signal of a linear PCM based on an MPEG or AC-3 standard. When the analog video signal and analog audio signal from the analog tuner 11 are inputted, the PS encoder 12 performs a predetermined encoding process. Specifically, the PS encoder 12 converts the video signal and audio signal into the digital signals and then encodes them, thereafter they are packed to be converted into a video pack, an audio pack, and a sub-picture pack. Further, they are combined and converted into a format suitable for a record to the HDD 14. The signal converted by the PS encoder 12 is sent to the data processor 13. Incidentally, the PS encoder 12 may directory send the A/D converted digital video signal and audio signal to the selector 16 without encoding them.

The data processor 13 receives the digital video signal and audio signal encoded by the PS encoder 12, and performs a data process to write to the subsequent HDD 14. Specifically, the data processor 13 respectively receives data in GOP units from a formatter included in the PS encoder 12 when contents of analog broadcast are recorded, and from a stream processor 22 when contents of digital broadcast are recorded, and records to the HDD 14. In addition, the data processor 13 also has a function to read a predetermined reproduction signal from the HDD 14. The data processor 13 includes a buffer circuit, a modulation/demodulation circuit, an error correction circuit, and so on, and performs a data process by each record or reproduction unit.

The HDD 14 is a recording apparatus which records and reproduces data by driving a storage medium such as, for example, a hard disk. The HDD 14 is not limited to the hard disk, but it may be the one capable of record/reproduction of the digital data.

The PS decoder 15 is a decoder including a separator separating and retrieving each pack such as picture and audio from a multiple signal recorded on the HDD 14 in a packed structure, a memory used at a time of performing a pack separation and other signal processes, a video decoder decoding main-picture data (contents of video pack) separated by the separator, a sub-picture decoder decoding the sub-picture data (contents of sub-picture pack) separated by the separator, and an audio decoder decoding audio data (contents of audio pack) separated by the separator. The PS decoder 15 may includes a video processor accordingly combining the decoded sub-picture to the decoded main-picture, and outputting the main-picture while lapping a menu, a highlight button, a closed-caption, and other sub-pictures on the main-picture. The PS decoder 15 decodes the video/audio signal of the analog broadcast wave basically A/D converted and recorded on the HDD 14.

The selector 16 is a signal switcher which selects an output signal from the PS decoder 15, an output signal from the TS decoder 25, an output signal from the PS encoder 12, and an output signal from the stream processor 22, and outputs to the D/A converter 17. Namely, the selector 16 selects any one of the analog broadcast wave signal recorded on the HDD 14, the digital broadcast wave signal similarly recorded on it, the analog broadcast wave signal digitalized by the PS encoder 12, or the digital broadcast wave signal from the stream processor 22. The selector 16 performs the selection based on a select signal from the CPU 31.

The D/A converter 17 converts the digital video signal and audio signal selected by the selector 16 into analog video signal and audio signal. The D/A converter 17 respectively outputs the analog converted video signal and audio signal to the display D and the speaker SP.

The digital tuner 21 corresponds to the analog tuner 11, and receives digital broadcast waves such as the terrestrial wave, BS, CS via the digital antenna A2. The digital tuner 21 extracts a TS packet such as picture and audio of the program selected by the user from among MPEG2-TS signals to input to the stream processor 22.

The stream processor 22 is a data converter performing a conversion process such that the picture data and audio data, extracted by the digital tuner 21 and divided into small TS packets, are processed into a large-sized packet suitable for the record to the HDD 14. Converted information is recorded to the HDD 14 via the data processor 13.

The TS decoder 25 corresponds to the PS decoder 15, and it is a decoder decoding a record signal of the digital broadcast wave read from the HDD 14 via the data processor 13. The TS decoder 25 includes a separator separating and retrieving the picture, audio, and so on from the recorded multiple signal, a video decoder decoding the separated picture data, and an audio decoder similarly decoding the separated audio data. The TS decoder 25 inputs the decoded digital video signal and audio signal to the selector 16.

The CPU 31 executes processes such as a defect position detection, an unrecorded area detection, a recording information record position setting, a UDF record, an AV address setting based on the control program. Besides, the CPU 31 has an information processor required for controlling all over the system, and includes a not-shown work RAM, a video management information creation unit, a copy related information detecting unit, a copy and scrambling information processor, a packet header processor, a sequence header processor, an aspect ratio information processor, and so on.

Besides, the CPU 31 also includes the edit management information controller 32 performing a control of management information when an edition is performed, and the record management information controller 33 performing a control of management information when the recording is performed. Further, the CPU 31 creates management information required for a reproduce of the recorded data, and transmits the management information created when the record of data is completed to the data processor 13. Accordingly, the management information is recorded to the HDD 14. Consequently, the CPU 31 receives information by a data unit (cut information and so on) from the PS encoder 12 when the data is encoded and from the stream processor 22 when the record of the MPEG2-TS signal is performed. The CPU 31 has functions to recognize management information of a file system read from a hard disk, recognize an unrecorded area of the hard disk, and set a data record area on the hard disk via the data processor 13 at the time when the record is started.

The edit management information controller 32 is a management data control processor editing management information corresponding to the video signal and audio signal recorded on the HDD 14.

The record management information controller 33 is a management data control processor controlling the record of the video signal and audio signal to the HDD 14 and performing the setting and so on of the management information.

The display unit 34 is a display device showing operation states and so on at the CPU 31 to the user, and it is composed of, for example, LCD elements and so on. The keyboard unit 35 is an input device inputting user's instructions to the CPU 31, and for example, it is a keyboard, a remote control unit, and so on.

Here, record and reproduction (playback) operations of the TV system 1 including the recording apparatus 10 of this embodiment are described.

In case of the analog broadcast signal, the analog tuner 11 receives radio waves of the analog broadcast waves from the analog antenna A1, performs a station selection and demodulation of the radio waves, converts into the analog video signal and audio signal, and outputs to the PS encoder 12. When the analog video signal and audio signal are received, the PS encoder 12 performs an A/D conversion of the video signal and audio signal, performs a packing (formatting) to output to the data processor 13. At this time, the CPU 31 creates the management information to send to the data processor 13. The data processor 13 records the received video signal and audio signal to the HDD 14 together with the management information.

Whereas, the video signal and audio signal recorded to the HDD 14 are read by the data processor 13 and passed to the PS decoder 15. The PS decoder 15 separates and decodes the packed signals of the read video signal and audio signal, and outputs to the selector 16. The selector 16 passes the received signal to the D/A converter 17. The D/A converter 17 performs the D/A conversion of the received digital video signal and audio signal to output to the display D and the speaker SP.

In case of the digital broadcast signal, the digital tuner 21 receives the radio waves of the digital broadcast waves from the digital antenna A2, performs the station section and demodulation of the radio waves, and extracts the digital video signal and audio signal. In case of the digital broadcast, the picture and audio are encoded at a broadcast station side, and they have a format of the MPEG2-TS signal. The stream processor 22 selects required packets from the received MPEG2-TS signal, converts from the TS packet to a packet for recording, and sends to the data processor 13. The data processor 13 records the received data to the HDD 14.

The video signal and audio signal of the digital broadcast wave recorded on the HDD 14 are read by the data processor 13 and sent to the TS decoder 25. The TS decoder 25 separates and decodes the packed signal of the read video signal and audio signal, to output to the selector 16. The selector 16 sends the received signal to the D/A converter 17. The D/A converter 17 performs the D/A conversion of the received digital video signal and audio signal to output to the display D and the speaker SP.

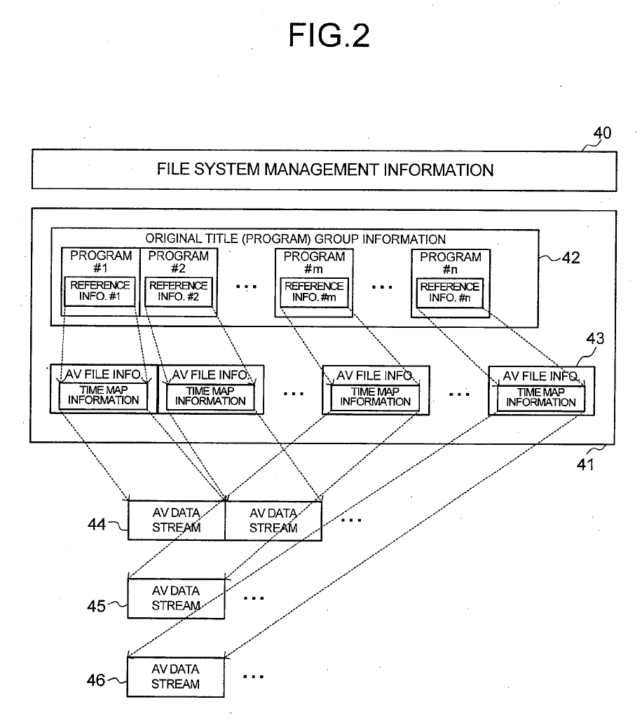

Next, a data configuration recorded to the HDD 14 by the recording apparatus 10 of this embodiment is described in detail with reference to FIG. 2. FIG. 2 is a schematic view showing an overview of the data configuration in the recording apparatus 10 of this embodiment.

As shown in FIG. 2, a record data in the recording apparatus 10 of this embodiment has file system management information 40, management information 41, a first AV stream file 44, a second AV stream file 45, and a third AV stream file 46, and they are respectively recorded on the HDD 14.

The management information 41 is information to manage position information, an attribute, and so on of the record data recorded on the HDD 14. The management information 41 has program group information 42 and AV file information 43.

The program group information 42 (original title group information) is information for managing a reproduction sequence (playback sequence information) of the recorded contents (program), and information concerning individual programs are organized by each program unit. The individual program information has reference information which is linked to AV file information being the information concerning the AV data stream (aggregate of the picture and audio data by the program unit) to be an object of the reproduction.

The AV file information 43 is a table associating the program group information 42 to be a management object of the user and the record data being an actual record data. The AV file information 43 has time map information in which logical address information of the corresponding AV data stream on the HDD 14 is described.

The first to third AV stream files 44 to 46 are data files composed of AV data streams respectively corresponding to programs (title: a unit in which the user records at one time). The individual AV data streams composing the first to third AV stream files 44 to 46 are composed of an information pack, a picture pack, an audio pack, a sub-picture pack, and so on. The information pack is an information package for the attribute and identification of the AV data stream, and includes information showing a start time when a first field of a GOP to which the information pack is belonging is reproduced, information showing a record time of the corresponding GOP, copy control information, and so on. The picture pack is an information package in which the video data is compressed by the MPEG2 system, and composed of a pack header, a packet header, and a video data portion. The audio pack is an information package in which the audio data is processed by, for example, the systems of the linear PCM, the MPEG, the AC-3, and so on, and composed of the pack header, the packet header, and an audio data portion.

The first AV stream file 44 is a data file prepared for the record and playback of a normal recording, and the second and third AV stream files 45 and 46 are data files prepared for a loop recording. Here, the “normal recording” means the record of which object is a saving, and the “loop recording” means the record in which a saving only for a certain period of time is enabled by overwrite recording within a predetermined area repeatedly.

The file system management information 40 is management information of, for example, a UDF (Universal Disk Format) standard, and it is the management information to manage the file of the management information 41, and the first to third AV stream files 44 to 46.

Incidentally, play list information composed of only information managing a reproduction sequence of the programs (playback sequence information) may be provided in addition to the program group information 42. The play list information does not have an AV data stream of its own, and it is generated by editing (deleting, adding) reference information which links to AV file information of an original title. Namely, it becomes possible to generate a program composed of only necessary scenes, and to generate a program in which unnecessary scenes are removed, by not processing the AV data stream directly but editing only the reference information. Besides, in an example shown in FIG. 2, the example is shown in which three stream files of the first to third AV stream files 44 to 46 are existing, but four or more AV stream files may exist.

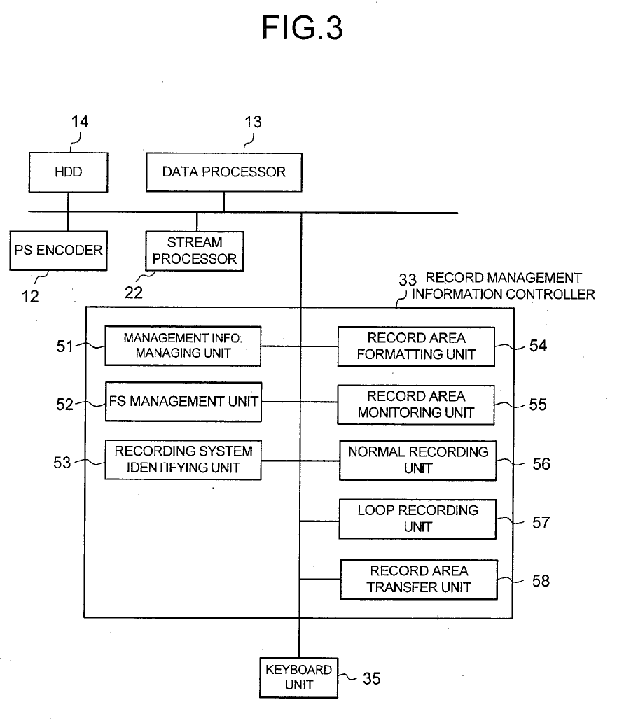

Subsequently, the record management information controller 33 in the recording apparatus 10 of this embodiment is described in detail with reference to FIG. 3. FIG. 3 is a block diagram showing a configuration of the record management information controller 33 shown in FIG. 1. The record management information controller 33 has a function to perform the recording process of the recording apparatus 10 of this embodiment.

As shown in FIG. 3, the record management information controller 33 in this embodiment has a management information managing unit 51, an FS management unit 52, a recording system identifying unit 53, a record area formatting unit 54, a record area monitoring unit 55, a normal recording unit 56, a loop recording unit 57, and a record area transfer unit 58. The recording apparatus 10 of this embodiment performs a recording by the data record configuration shown in FIG. 2, namely, a configuration in which the AV stream file for the normal recording and the AV stream file for the loop recording are configured separately.

The management information managing unit 51 is an information processor managing the program group information 42 and the AV file information 43 shown in FIG. 2. The management information managing unit 51 provides the program group information recorded on the HDD 14 to the user via the display unit 34 and the display D, and has a function to set the program group information at the time of recording. The program group information 42 managed by the management information managing unit 51 includes time information by each program (time information showing a position within a data recorded on the HDD 14). Besides, the AV file information 43 managed by the management information managing unit 51 includes logical address information corresponding to logical position information of the record data.

The FS management unit 52 is an information processor managing the file system management information 40 based on, for example, the UDF (Universal Disk Format) standard. In the recording apparatus 10 of this embodiment, the record data by each program continues to constitute the AV stream file. FS management information is identification information of this AV stream file, and the FS management unit 52 manages the AV stream file via the FS management information.

The recording system identifying unit 53 is a recording system management processor identifying the recording system of instruction contents from the user inputted from the keyboard unit 35. As the recording systems managed by the recording system identifying unit 53, there are two recording systems of the normal recording performing the normal recording, and the loop recording performing the recording while overwriting the predetermined area repeatedly. The instruction from the user may be an explicit one, or it may be the one understood to be instructed as long as it is not released. For example, it may be constituted such that the loop recording is started simultaneously with the power on.

The record area formatting unit 54 is a management processor securing and managing the record area of the HDD 14. The record area formatting unit 54 has a function securing or releasing the record areas of the first to third AV stream files 44 to 46 for the HDD 14 beforehand.

The record area monitoring unit 55 is a monitoring processor monitoring the record area prepared by the record area formatting unit 54. The record area monitoring unit 55 has functions to monitor the record area prepared by the record area formatting unit 54, and to notify the monitored result to the normal recording unit 56 or the loop recording unit 57.

The normal recording unit 56 is a processor performing the normal recording process, and has a function to instruct the data processor 13 to perform the normal recording of the video data and audio data transmitted from the PS encoder 12 or the stream processor 22 to the HDD 14.

The loop recording unit 57 is a processor performing the loop recording process. The loop recording unit 57 has a function to instruct the data processor 13 to perform the loop recording of the video data and audio data transmitted from the PS encoder 12 or the stream processor 22 to the HDD 14.

The record area transfer unit 58 is a data transfer processor logically transferring the data recorded as the AV data stream between the AV stream files. The record area transfer unit 58 has a function to transfer an area between later-described predetermined chapters from the recorded second and third AV stream files 45 and 46 to the first AV stream file 44. The transfer between the AV stream files is realized by a change of the logical addresses, and therefore, the transfer of actual recorded positions is not performed. Accordingly, a high-speed processing becomes possible compared to a case when the AV data stream is just processed to transfer.

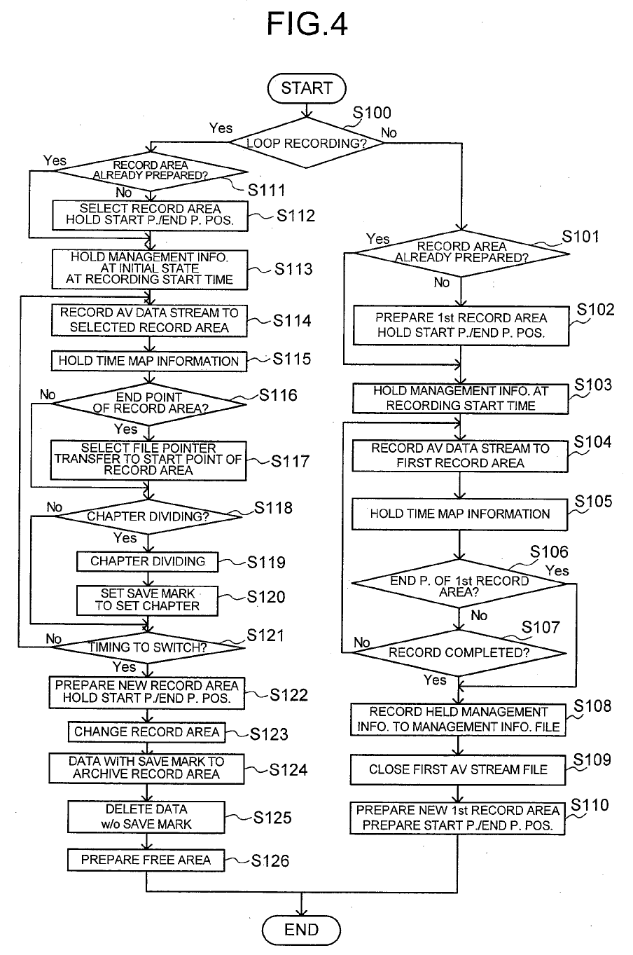

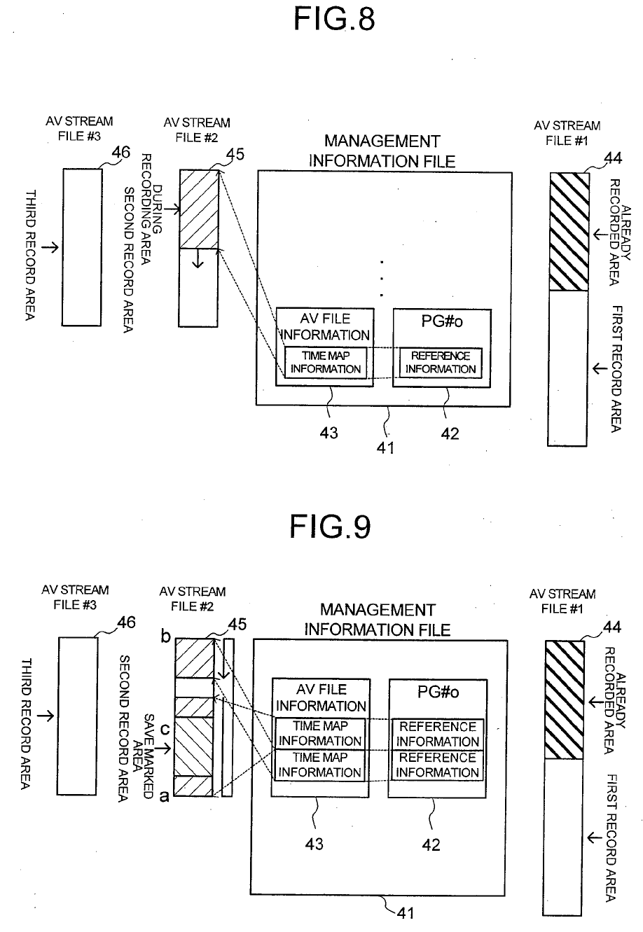

Next, operations of the recording apparatus 10 according to this embodiment are described with reference to FIG. 4 to FIG. 11. FIG. 4 is a flow chart showing record operations of the recording apparatus 10 of this embodiment, FIG. 5 to FIG. 7 are schematic views showing the record operations of the normal recording in this embodiment, and FIG. 8 to FIG. 11 are schematic views similarly showing the record operations of the loop recording.

At first, states of the management information 41, the first AV stream file 44, the second AV stream file 45, and the third AV stream file 46 in initial states are shown in FIG. 5. Here, a first record area for the normal recording is prepared at the first AV stream file 44 used for the normal recording. On the other hand, a second and third record areas for the loop recording are respectively prepared at the second AV stream file 45 and the third AV stream file 46 used for the loop recording. In an example shown in FIG. 5, titles from PG #1 to PG #m are already recorded as the program group information 42 recorded by the normal recording, and a recorded area is formed on the first AV stream file (bold oblique line area in FIG. 5). However, hereinafter, these representations may not be given as a matter of convenience of explanation.

When the keyboard unit 35 receives the instruction of the user, the recording system identifying unit 53 judges whether the user's instruction is the loop recording or not (step 100 in FIG. 4. Hereinafter, it is represented by “S100”). When the user's instruction is the normal recording (“No” in S100), the recording system identifying unit 53 instructs the normal recording unit 56 to perform the normal recording process. When the normal recording instruction is received, the normal recording unit 56 inquires of the record area monitoring unit 55 if the record area for the normal recording is prepared or not (S101). When the inquiry is received, the record area monitoring unit 55 inquires of the FS management unit 52 about where the record area for the normal recording is prepared from among the first to third AV stream files 44 to 46. In this example, the normal recording is assigned to the first AV stream file 44, and therefore, the FS management unit 52 replies the file system in which the first AV stream file 44 is existing as the file system for the normal recording. The record area monitoring unit 55 judges whether the record area for the normal recording (hereinafter, referred to as a “first record area”) is prepared on the first AV stream file 44 on the file system replied by the FS management unit 52, and passes a judged result to the normal recording unit 56.

When the first record area is not prepared (“No” in S101) as the result of the judgment, the normal recording unit 56 instructs the record area formatting unit 54 to prepare the first record area. The record area formatting unit 54 forms the first record area on the first AV stream file 44 of the HDD 14, and returns logical addresses of a start point and end point to the normal recording unit 56 (S102). FIG. 5 shows this state.

When the first record area is already prepared (“Yes” in S101) as the result of the judgment, or when the first record area is prepared by the record area formatting unit 54, the normal recording unit 56 generates management information at an initial state at a recording start time, to hold on an internal memory (S103). Specifically, the normal recording unit 56 instructs the management information managing unit 51 to generate the management information 41 concerning a whole contents to be recorded from among the program group information 42, the reference information, and the AV file information 43. When the instruction is received, the management information managing unit 51 receives the logical addresses of the start point and end point of the first record area returned by the record area formatting unit 54 from the normal recording unit 56, and sets as the time map information of the AV file information 43.

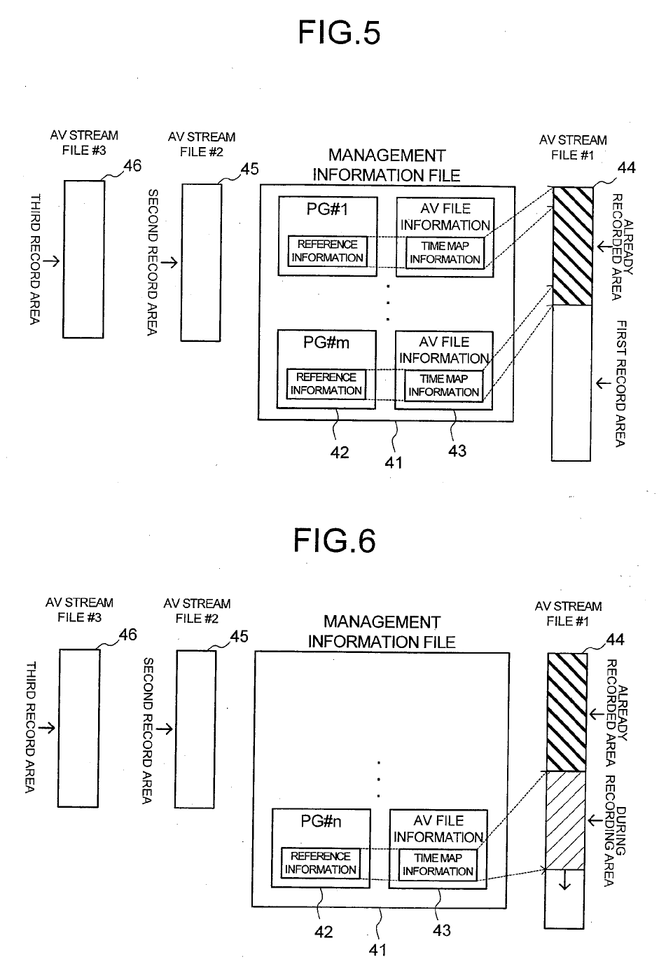

When the management information 41 is generated, the normal recording unit 56 records the video data and audio data transmitted from the PS encoder 12 or the stream processor 22 to the first record area prepared at the first AV data stream 44 on the HDD 14 (S104). Incidentally, during the recording to the first record area, the management information managing unit 51 momentarily generates the time map information reflecting a progress portion of the record of the AV data stream to record to the AV file information 43 on a memory (S105). FIG. 6 shows a state in which the normal recording is performed to the first record area of the first AV stream file 44. In FIG. 6, the record of contents by the normal recording is newly performed as a title of a PG #n. As shown in FIG. 6, the AV data stream (fine oblique line portion) recorded by the normal recording is recorded within the first record area, and the time map information being the management information corresponds to the AV data stream recorded to the first record area.

The record area monitoring unit 55 monitors a state of the first record area recorded by the normal recording unit 56 while the recording process of the normal recording unit 56, to notify to the normal recording unit 56 (S106). Specifically, the record area monitoring unit 55 asks a position on a recording medium up to where the AV data stream is recorded (position on the first AV stream file 44) from the time map information generated by the management information managing unit 51, and judges arrival at the end point of the first record area by comparing with the held position of the end point of the first record area (logical address on the recording medium).

When the record position of the normal recording unit 56 is not the end point of the first record area (“No” in S106), the normal recording unit 56 judges whether the recording is completed or not, and continues the recording process as it is (S104) if the recording is not completed (“No” in S107).

When the record position of the normal recording unit 56 is the end point of the first record area (“Yes” in S106) or the normal recording unit 56 judges that the recording is completed (“Yes” in S107), the normal recording unit 56 instructs the management information managing unit 51 to complete the recording. When the instruction is received, the management information managing unit 51 records the management information 41 recorded until that time to the HDD 14 as the management information file (S108), the normal recording unit 56 completes the recording process, and the management information managing unit 51 closes the first AV stream file (S109).

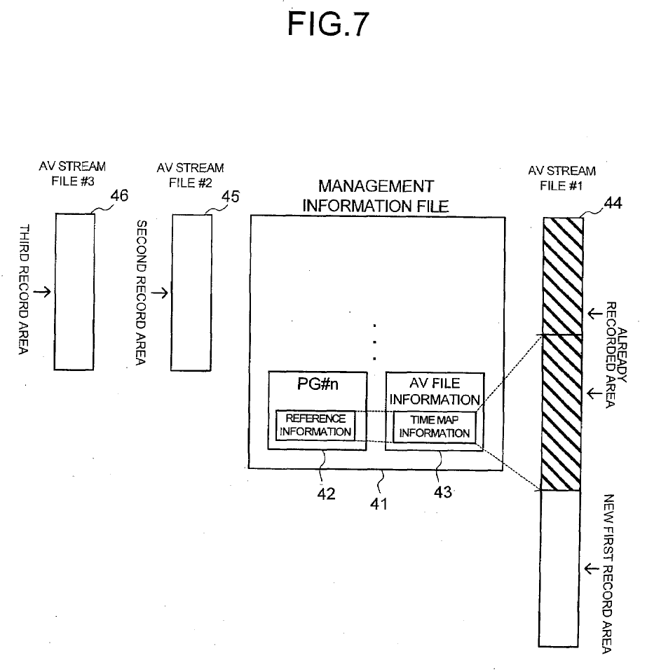

After that, the record area formatting unit 54 forms a new first record area, and sends the logical addresses of the start point and the end point thereof to the management information managing unit 51 (S110). Accordingly, the preparing of the record area in the step S102 becomes unnecessary at the time of next normal recording. FIG. 7 shows a state when the normal recording to the first AV stream file 44 is completed. Here, a new first record area is prepared at the first AV stream file 44 for the next normal recording with corresponding to the completion of the recording of the title PG #n (bold oblique line).

When the user's instruction received from the keyboard unit 35 is the loop recording (“Yes” in S100), the recording system identifying unit 53 instructs the loop recording unit 57 to perform the loop recording process. When the loop recording instruction is received, the loop recording unit 57 inquires of the record area monitoring unit 55 whether the record area for the loop recording is prepared or not (S111). When the inquiry is received, the record area monitoring unit 55 inquires of the FS management unit 52 about where the record area for the loop recording is prepared from among the first to third AV stream files 44 to 46. In this example, the loop recording is assigned to the second and third AV stream files 45 and 46, and therefore, the FS management unit 52 replies the file system where the second AV stream file 45 of the first is existing as the file system for the loop recording. The record area monitoring unit 55 judges whether the record area for the loop recording (hereinafter referred to as a “second record area”) is prepared or not on the second AV stream file 45 on the file system which is replied by the FS management unit 52, and returns the judged result to the loop recording unit 57.

When the second record area is not prepared (“No” in S111) as the result of the judgment, the loop recording unit 57 instructs the record area formatting unit 54 to prepare the second record area. The record area formatting unit 54 forms the second record area at the second AV stream file 45 of the HDD 14, and returns the logical addresses of the start point and end point thereof to the loop recording unit 57 (S112). Incidentally, at the time of this step S112, a process to form a third record area at the third AV stream file 46 in addition to the second record area may be performed simultaneously.

When the second record area is already prepared as the result of the judgment (“Yes” in S111) or when the second record area is prepared by the record area formatting unit 54, the loop recording unit 57 generates the management information 41 at an initial state at the recording start time, to hold on an internal memory (S113). Specifically, the loop recording unit 57 instructs the management information managing unit 51 to generate the management information 41 concerning a whole contents to be recorded from among the program group information 42, the reference information, and the AV file information 43. When the instruction is received, the management information managing unit 51 receives the logical addresses of the start point and end point of the second record area returned by the record area formatting unit 54 from the loop recording unit 57, and sets as the time map information of the AV file information 43.

When the management information 41 is generated, the loop recording unit 57 records the video data and audio data transmitted from the PS encoder 12 or the stream processor 22 to the second record area prepared at the second AV data stream on the HDD 14 (S114). Incidentally, during the record to the second record area, the management information managing unit 51 momentarily generates the time map information reflecting a progress portion of the record of the AV data stream to record to the AV file information 43 on the memory (S115). FIG. 8 shows a state in which the loop recording is performed to the second record area of the second AV stream file 45. In FIG. 8, the record of contents by the loop recording is newly performed as a title of PG #o. As shown in FIG. 8, the AV data stream (fine oblique line portion) recorded by the loop recording is recorded inside of the second record area, and the time map information being the management information corresponds to the AV data stream recorded at the second record area.

During the record process of the loop recording unit 57, the record area monitoring unit 55 monitors a state of the second record area recorded by the loop recording unit 57 to notify to the loop recording unit 57 (S116). Namely, the record area monitoring unit 55 calculates a position on the recording medium up to where the AV data stream is recorded (which position on the second AV stream file 45) base on the time map information generated by the management information managing unit 51, and judges arrival at the end point of the second record area by comparing the held position of the end point of the second-record area (logical address on the recording medium).

When a record position of the loop recording unit 57 is not the end point of the second record area (“No” in S116), the loop recording unit 57 continues the loop recording process as it is.

When the record position of the loop recording unit 57 is the end point of the second record area (“Yes” in S116), the loop recording unit 57 transfers a file pointer (record point) of the second AV stream file 45 to the held position of the start point of the second record area (logical address on the recording medium) (S117). Accordingly, the record of a subsequent AV data stream is performed as an overwrite record from the start point of the second record area, and the overwrite record in which inside of the prepared second record area is used repeatedly, namely the loop recording is executed.

Here, when a fold-back is occurred at the second record area, it is necessary to adjust the start point position starting the record of the second AV data stream 45 in the time map information. The management information managing unit 51 shifts the start point position starting the record of the subsequent AV data stream backward in terms of time by the overwrite recording.

FIG. 9 represents a state in which the fold-back at the second record area is occurred under a state in the middle of the loop recording to the second AV stream file 45. The AV data stream older in terms of time is the AV data stream of “a” in the drawing among the AV data streams recorded by the loop recording. However, an end of this AV data stream of “a” reaches the end point of the second record area, and therefore, the file pointer of the second AV stream file 45 is reset to the start point of the second record area, and the subsequent portion is recorded as an AV data stream of “b”. At this time, the AV data stream of “b” is sequentially overwrite recorded from a position former than a beginning of the AV data stream of “a”, and therefore, the time map information indicating the AV data stream of “a” shifts the start point position of the indicated AV data stream of “a” in accordance with the overwrite record of the AV data stream of “b”.

Incidentally, in FIG. 9, the time map information indicating the respective AV data streams are provided separately as a result that a connection point of the AV data stream of “a” and the AV data stream of “b” becomes discontinuous caused by the occurrence of the fold-back. However, it is not limited to the above, and for example, it may have a mechanism in which all over the second record area is indicated by one time map information, and the information of the start point/end point of the recorded AV data stream is held separately and uniquely. Besides, in FIG. 9, a certain interval is provided between an ending of the AV data stream of “b” and the beginning of the AV data stream of “a”, but it is not necessarily required.

During the execution of the loop recording process, the loop recording unit 57 is constantly in a state capable of receiving a chapter dividing instruction. For example, the loop recording unit 57 adds a chapter boundary (for example, a mark showing a cut line of a program and so on) to the data during the loop recording to set a partial area called as a chapter within the title (S119), when the chapter dividing instruction is inputted from the keyboard unit 35 and conditions of rules which are set in advance (specific elapsed time, change of data attributes such as sub-voice, and so on) are satisfied (“Yes” in S118). The chapter division may be performed automatically by detecting the cut line of the program, as the rule to perform the chapter division. Besides, the user may perform the chapter division manually after a positioning is performed by executing the chasing playback during the loop recording, or these two methods may be combined. The set chapter is formed within the record data as a specific area surrounded by two chapters of the start point and end point.

Subsequently, the loop recording unit 57 sets marks such as “save” and “discard” for the chapter set in the step 119 (S120). Specifically, words such as the “save” and “discard” are added as a chapter name or as a part of the chapter name, or a flag is provided in addition to the chapter name, and values having meanings of the “save” and “discard” maybe set to the flag. Here, a mark to identify whether it is the chapter to be saved or not is to be given, and therefore, various means can be adopted other than the above as long as it is along a purpose thereof. A reference symbol “c” in FIG. 9 shows a state in which the mark of “save” is set.

The loop recording is continued even if the mark is set, and therefore, it is necessary for the loop recording unit 57 to perform a process to switch a record object file to another AV stream file at an appropriate timing before the chapter having the “save” mark is disappeared by the overwrite recording. The timing to switch the record object file is not particularly limited as long as it is before the chapter having the “save” mark is disappeared by the overwrite record. However, there is a possibility that some lack of pictures may occur when the record object file is switched, and therefore, for example, a means is conceivable in which the record object file is switched at the timing when the cut line of the program is detected after the latest chapter having the “save” mark in a recorded time sequence.

Specifically, at a predetermined switch timing (“Yes” in S121), the loop recording unit 57 inquires of the record area monitoring unit 55 whether the record area for the loop recording is prepared or not (S122). When the inquiry is received, the record area monitoring unit 55 inquires of the FS management unit 52 about where the record area for the loop recording is prepared from among the first to third AV stream files 44 to 46. In this example, the loop recording is assigned to the second and third AV stream files 45 and 46, and the FS management unit 52 replies the file system in which the third AV stream file 46 is existing as a secondary file system for the loop recording because the second AV stream file 45 is already selected. The record area monitoring unit 55 judges whether the record area for the loop recoding (hereinafter, referred to as a “third record area”) is prepared on the third AV stream file 46 on the file system replied by the FS management unit 52 or not, and returns the judged result to the loop recording unit 57.

When the third record area is not prepared as the result of the judgment, the loop recording unit 57 instructs the record area formatting unit 54 to prepare the third record area. The record area formatting unit 54 forms the third record area on the third AV stream file 46 of the HDD 14, and returns logical addresses of the start point and end point thereof to the loop recording unit 57. When the third record area is already prepared as the result of the judgment, or the third record area is prepared by the record area formatting unit 54, the loop recording unit 57 generates the management information 41 at an initial state at the recording start time, to hold on an internal memory (S122). Specifically, the loop recording unit 57 instructs the management information managing unit 51 to generate the management information 41 concerning a whole contents to be recorded from among the program group information 42, the reference information, and the AV file information 43. When the instruction is received, the management information managing unit 51 receives the logical addresses of the start point and end point of the third record area returned from the record area formatting unit 54 from the loop recording unit 57, and set the addresses as the time map information of the AV file information 43.

When the management information 41 is generated, the loop recording unit 57 stops the loop recording for the second record area on the second AV stream file 45, and starts the record of the video data and audio data transmitted from the PS encoder 12 or the stream processor 22 to the third record area prepared on the third AV stream file 46 on the HDD 14 (S123). Accordingly, the area of the loop recording is changed from the second record area to the third record area, and the loop recording without approximately any cut line is continued.

Incidentally, when the chapter having the “save” mark does not exist, the loop recording may be continuously performed for the same record object file as it is, or the record object file may be switched at an appropriate timing such as after a predetermined time is elapsed even in such a case.

Next, the loop recording unit 57 instructs the management information managing unit 51 to save the data having the “save” mark at a predetermined timing (S124). When the instruction is received, the management information managing unit 51 updates the management information 41 corresponding to the data between the chapters in which the “save” mark are set, as the management information file corresponding to the first record area of the first AV stream file 44 of the HDD 14. Namely, the management information managing unit 51 transfers the area having the “save” mark from among the area in which the AV data streams are recorded within the second record area by the loop recording, from the second AV stream file to the first AV stream file while matching the playback sequence. For example, when the file system based on the UDF (Universal Disk Format) standard is used, a process in which an extent corresponding to the area where the AV data stream is recorded is transferred from a file entry of the second AV stream file to a file entry of the first AV stream file, is performed by the FS management unit 52.

Besides, the management information managing unit 51 records the time map information of the data recorded as the loop recording while changing into the logical address after it is transferred to the first record area of the first AV stream file 44. This means that the record data which is loop recorded and has the “save” mark is logically managed as the record data which is normal recorded. Besides, the fold-back portion occurred on the second AV stream file 45 (divided portion of the AV data stream) is rearranged in sequence and recorded by being integrated into one time map information.

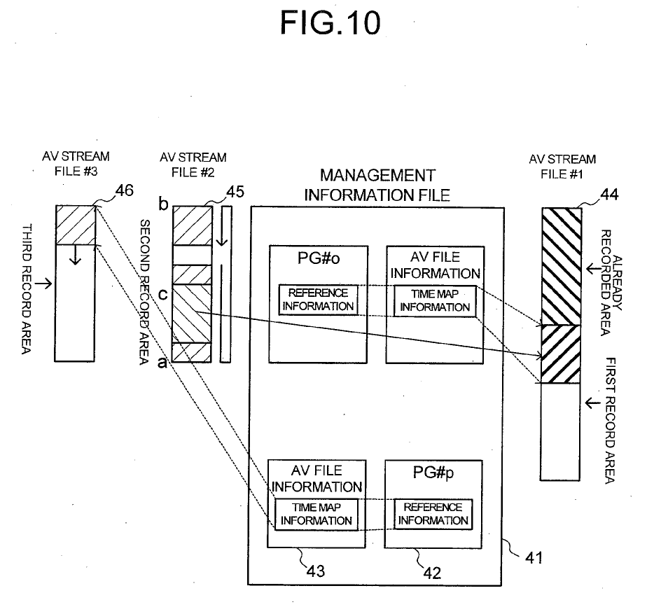

The change process of the loop recording object from the second record area to the third record area, and the save process of the “save” set area on the second record area to the first record area are performed in parallel. Namely, the record object file is switched to the new AV stream file to perform the loop recording, and the process for the save object file is performed in parallel. FIG. 10 shows a state in which these two processes are performed in parallel.

Subsequently, the record area transfer unit 58 discards the AV data stream of a portion other than the chapter having the “save” mark (S125). By this process, the area to which the AV data streams not saved to an archive file (here, the first AV stream file 44) are recorded, is made to be an unused state and released as an area to be overwrite recorded for a next recording time.

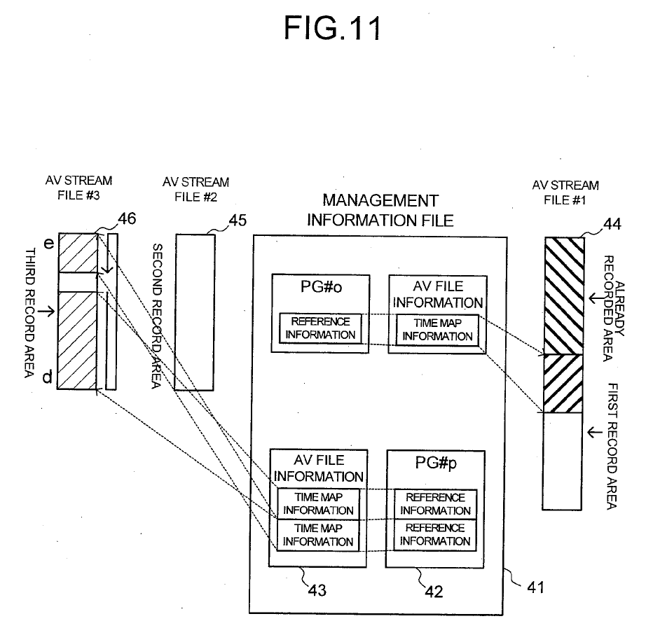

The record area formatting unit 54 resets the save object file to have a free area with a predetermined amount, and makes it usable as a new record object file for the next loop recording (S126). FIG. 11 shows a state in which the second record area is reset.

As a result that the management information managing unit 51 records the management information file, the already recorded area recorded on the second AV stream file 45 is transferred to the first AV stream file 44, set to the program group information 42 as an already recorded area, and placed under a management in common with the already recorded area of the first AV stream file 44 which is normal recorded.

Incidentally, a simple procedure may be adopted as follows to simplify the configuration: [1] Stop the loop recording for the first record object file; [2] Switch the record object file; [3] Restart the loop recording for the new record object file. On the other hand, for example, buffer capacity of the AV stream data is set more than required, and ingenuity may be exercised such that a lack of pictures when the record object file is switched becomes small as much as possible. Besides, the timing to stop the loop recording for the first record object file is a little delayed, and the loop recording for the new record object file is started in advance. After that, the loop recording for the first record object file is continued for a while in parallel to provide so-called a overlap width area, to thereby prevent the occurrence of the lack of pictures caused by the switching of the record object file.

As stated above, according to the recording apparatus 10 of this embodiment, the management information managing unit 51 manages the management information of the normal recording and the management information of the loop recording by the common program group information 42 and the AV file information 43, and therefore, it is possible to provide the management information to the user as the program information without any distinction between the normal recording and the loop recording.

Besides, according to the recording apparatus 10 of this embodiment, when the save setting is made between predetermined chapters by the user's instruction or the predetermined rule, the transfer of data between the corresponding chapters to the save area and the change of the loop recording area are performed concurrently, and therefore, it is possible to save a desired area without stopping the loop recording.

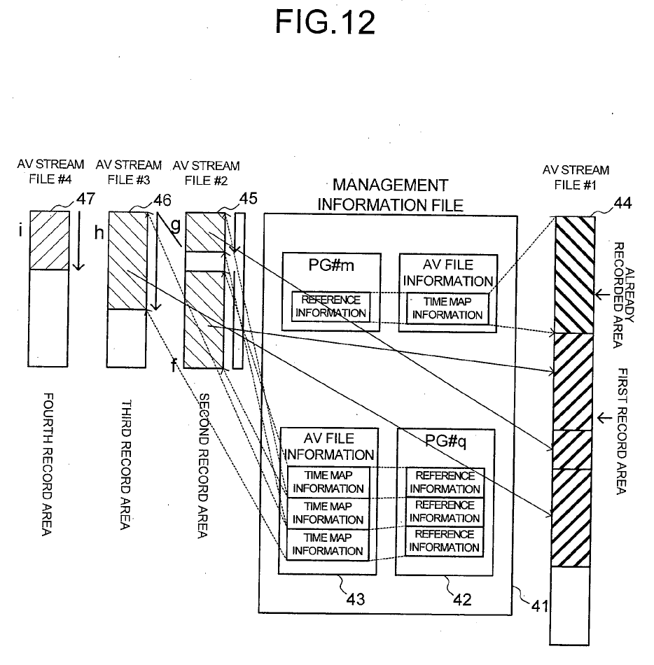

Next, a recording apparatus according to another embodiment of the present invention is described with reference to FIG. 12. FIG. 12 is a schematic view showing loop recording operations of the recording apparatus according to a second embodiment of the present invention. The recording apparatus of the second embodiment has a similar configuration with the recording apparatus of the first embodiment shown in FIG. 1 and FIG. 3, and only a point that the loop recording areas are included three or more is different. Therefore, a redundant description is not given.

In the recording apparatus of the first embodiment, the continuous loop recording is enabled by performing the loop recording for the third record area while the “save” mark setting area of the second record area is save processed to the first record area. However, when the setting of the “save” mark is performed by the user's instruction, it is conceivable that the “save” mark setting area does not fall in the second record area, and in such a case, the continuous loop recording becomes impossible.

Accordingly, in the recording apparatus of the second embodiment, the second to a fourth AV stream files 45 to 47 are prepared as the loop recording areas. Namely, when the “save” mark setting area exceeds the second record area, specifically, when it rises to a step in which a whole area of the second record area is loop recorded under a state that a second time chapter setting is not performed after a first time chapter setting, the loop recording unit 57 instructs the record area formatting unit 54 to prepare the third record area as a new loop recording area. Then, an object of the loop recording is changed to the third record area before a current record position reach the chapter position of the first time which is set in advance, and the loop recording is continuously performed.

When the chapter setting of the second time is performed on the third record area, the loop recording unit 57 makes the second record area and the third record area as candidate areas for the “save” mark setting, the loop recording to the third record area is stopped, and a new loop recording is started from a fourth record area. When the “save” mark is set on the second and third record areas, the corresponding setting areas are save processed to the first record area. FIG. 12 shows a state in which the loop recording process for the fourth record area (“i” in FIG. 12) and the save process of the “save” marked areas set on the second and third record areas to the first record area (“f”, “g”, “h” in FIG. 12) are performed in parallel. Incidentally, a securing process of a new record area, a transfer process of the “save” mark setting area to the first record area, and so on can be realized by similar processes with the first embodiment.

It becomes possible to perform the saving of the save area without stopping the loop recording, even when the “save” mark setting area exceeds one record area, owing to the configuration and operations as stated above.

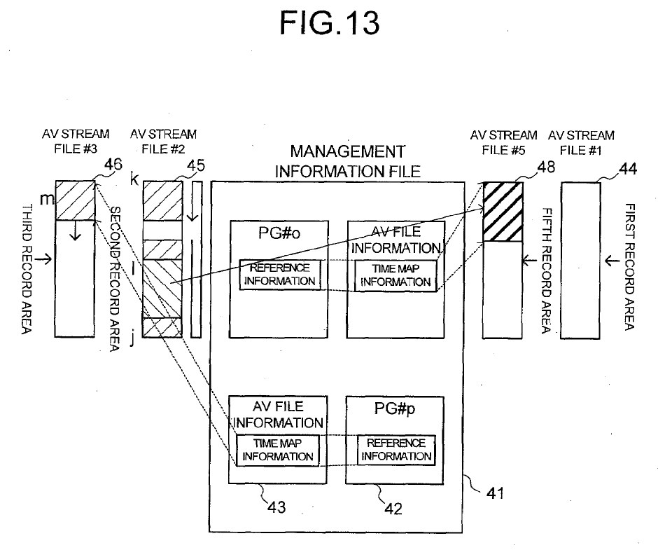

Next, a recording apparatus according to still another embodiment of the present invention is described with reference to FIG. 13. FIG. 13 is a schematic view showing loop recording operations of the recording apparatus according to a third embodiment of the present invention. The recording apparatus of the third embodiment has a similar configuration with the recording apparatus of the first embodiment shown in FIG. 1 and FIG. 3, and only a point is different in which a fifth record area is included as a record area for an archive saving (semi-permanent saving) in addition to the normal recording and the loop recording. Therefore, the redundant description thereof will not be given.

In the recording apparatus of the first embodiment, the record area transfer unit 58 transfers the “save” mark setting area to the first record area being the normal recording area, but a needs exists that it is managed not as the normal recording but as the semi-permanent saving. In the recording apparatus of the third embodiment, the point as stated above is considered, and the record area transfer unit 58 transfers the “save” marked area not to the first record area but to the fifth record area prepared in advance as for an archive saving. FIG. 13 shows a state in which the loop recording to the third record area (“m” in FIG. 13) and the saving process of the “save” mark setting area on the second record area to the fifth record area (“1” in FIG. 13) are performed in parallel. Incidentally, the securing process of a new record area, the transfer process of the “save” mark setting area to the fifth record area, and so on, can be realized by a similar process with the first embodiment. Convenience for the user can further be heightened by the configuration and operations as stated above. Incidentally, the AV data stream recorded by the normal recording may be transferred to the fifth record area for the archive saving after the normal recording is stopped, as same as the loop recording. In this case, the first AV stream file 44 is in a position that it is a temporary work stream file. On the other hand, it may have a configuration in which the AV data stream conventionally recorded by the normal recording may be remained in the first AV stream file 44 as it is after the normal recording is stopped.

Incidentally, it should be noted that the present invention is not limited to the above-described embodiments as they are, and in an implementation stage, it can be embodied by modifying components thereof within a range not departing from the spirit of the invention. Also, the plural components disclosed in the above-described embodiments can be appropriately combined to form various inventions. For example, some of all the components shown in the embodiments may be eliminated. Moreover, components from different embodiments may be combined appropriately. Namely, the AV stream files for the normal recording may be provided two or more, the AV stream files for the loop recording may be provided three or more, the AV stream files for archive may be provided two or more, or those may be combined.

According to the means described in the embodiments, the contents recorded by the loop recording are comprehensively managed by the same one management information with the contents recorded by the normal recording. Accordingly, a means of the loop recording in which the user can playback and view the contents later is realized, and a convenience for the user can be improved. The contents recorded by the loop recording are saved and comprehensively managed as same as the contents recorded by the normal recording. Accordingly, the means of the loop recording which enables the reproduction and view of the contents later is realized, and the convenience for the user is improved.

Besides, by the means described in the embodiments, it becomes possible to save a desired area from the loop recorded picture contents without stopping the loop recording as much as possible.

The above-stated embodiments are described based on a hardware configuration, but it may be realized by software such as a computer program. The software may be stored in a storage medium readable by a computer such as a flexible disk, or it may be transmitted as stand-alone software. In this case, the processes in the respective embodiments become possible by reading the software stored in the storage medium by the computer, or downloading and installing from a site (server) on an LAN or Internet.

Namely, the software (program) in the present invention is not limited to the one stored in the storage medium independent of the computer, and the one distributed via transmission media such as the LAN, and Internet may be included.

Incidentally, as the storage medium, a storage format may be in any mode as long as it is the storage medium capable of storing the program and the recode data, and being read by the computer and soon, such as, for example, a magnetic disk, an optical disk (CD-ROM, CD-R, DVD, and so on), an optical magnetic disk (MO and so on), a semiconductor memory in addition to the flexible disk.

Besides, an OS (operating system) running on the computer based on instructions of the program installed from the storage medium to the computer and so on, MW (middleware) such as database management software, network software may execute a part of the respective processes to realize the present embodiment.

Further, as the storage medium, the storage medium in which the program transmitted by the LAN, Internet, and so on is downloaded and stored, or temporary stored may be included without limited to the media independent of the computer. Besides, the storage medium is not limited to one, and the case when the processes in the present embodiment are executed from plural media may also be included in the storage medium in the present invention, and a media configuration may have any configurations.

Incidentally, the computer executes the respective processes in the present embodiment based on the program stored in the storage medium, and it may have any configuration such as a device composed of one of a personal computer and so on, a system to which plural devices are connected via network.

Besides, the computer is not limited to the personal computer, but a processor, a microcomputer, and so on included in information processing devices are included, and equipments, devices capable of realizing the functions of the present invention by the program are generically called as the computer.

Additional effects and corrections are easily performed by those in the art. Consequently, the invention with wide range of modes is not limited by the embodiments shown and described as specific detailed contents and a representative thereof. Accordingly, the embodiments of the present invention are to be understood that all the changes and modifications without departing from the spirit and scope of the invention as defined by the following claims and equivalency thereof are to be included therein.

What is claimed is:

1. A recording apparatus for recording stream data to a storage medium, comprising:
a first area generator configured to generate a first record area for recording a first stream data on the storage medium;
a second area generator configured to generate a second record area and a third record area on the storage medium for repeatedly overwriting a second stream data, the second stream data being provided as a reproduction object only for a predetermined period different from the first stream data;
a management information managing unit configured to record a management information file having management information of the first stream data recorded on the first record area and management information of the second stream data recorded on the second and third record areas to the storage medium;
a recording unit for recording the second stream data to the second record area, stopping the record of the second stream data to the second record area based on a save instruction of the second stream data, and restarting the record of the second stream data to the third record area;
a management information editor for updating the management information of the second stream data to the management information file as a stream data which is not to be overwrite recorded when said recording unit stops the record of the second stream data to the second record area; and
an area transfer unit for transferring the second stream data corresponding to the updated management information from the second record area to the first record area, when said management information editor updates the management information of the second stream data to the management information file.

2. The recording apparatus according to claim 1,
wherein the first record area, the second record area, and the third record area are formed on a common file system.

3. The recording apparatus according to claim 1,
wherein said recording unit continues the record of the second stream data continuously from a start point of the second record area when the second stream data is recorded up to an end point of the second record area.

4. The recording apparatus according to claim 1,
wherein said management information editor updates the management information corresponding to a predetermined area among the second stream data as a stream data which is not overwrite recorded to the management information file; and
wherein said area transfer unit transfers the stream data corresponding to the predetermined area corresponding to the updated management information from the second record area to the first record area.

5. The recording apparatus according to claim 1,
wherein said second area generator further generates a fourth record area for repeatedly overwriting the second stream data;
wherein said recording unit records the second stream data to the third record area in addition to the second record area when a data amount according to the save instruction of the second stream data exceeds capacity of the second record area, stops the record of the second stream data to the second record area and third record area based on the save instruction, and restarts the record of the second stream data to the fourth record area;
wherein said management information editor updates the management information of the second stream data as the stream data which is not overwrite recorded to the management information file, when said recording unit stops the record of the second stream data to the second record area and third record area; and
wherein said area transfer unit transfers the second stream data corresponding to the updated management information from the second record area and third record area to the first record area when said management information editor updates the management information of the second stream data to the management information file.

6. The recording apparatus according to claim 1, further comprising:
a third area generator configured to generate a fifth record area for recording a third stream data different from the first and second stream data on the storage medium, and
wherein said area transfer unit transfers the second stream data corresponding to the updated management information from the second record area to the fifth record area.

7. A recording method, comprising:
recording a first stream data to a first record area of a storage medium, the first stream data being provided as a reproduction object only for a predetermined period;
continuing the record of the first stream data from a start point of the first record area when the first stream data is recorded up to an end point of the first record area;
stopping the record of the first stream data based on a save instruction for saving the recorded first stream data;
setting management information such that the recorded first stream data is a data to be saved when the record of the first stream data is stopped; and
starting the record of the first stream data to a second record area different from the first record area of the storage medium, when the management information is set.

8. The recording method according to claim 7,
wherein the first record area and the second record area are formed on a common file system.

9. The recording method according to claim 7, further comprising:
transferring the first stream data recorded on the first record area to a third record area for storing the first stream data as a second stream data corresponding to the management information set by the setting of the management-information.

10. The recording method according to claim 9,
wherein said setting of the management information is performed to update the management information corresponding to a predetermined area among the recorded first stream data as a stream data which is not overwrite recorded to a management information file; and
wherein said transferring of the recorded first stream data is performed to transfer the first stream data corresponding to the predetermined area corresponding to the updated management information from the first record area to the third record area.

11. The recording method according to claim 9,
wherein said recording of the first stream data is performed to record the first stream data to the second record area in addition to the first record area when a data amount according to the save instruction exceeds capacity of the first record area, stop the record of the first stream data to the first record area and second record area based on the save instruction, and restart the record of the first stream data to a fourth record area for repeatedly overwriting the first stream data;
wherein said setting of the management information is performed to update the management information as a stream data which is not overwrite recorded to a management information file, when said recording of the first stream data to the first record area and second record area is stopped; and
wherein said transferring of the recorded first stream data is performed to transfer the recorded first stream data corresponding to the updated management information from the first record area and second record area to the third record area when said management information is updated to the management information file.

12. The recording method according to claim 9,
wherein said transferring of the recorded first stream data is performed to transfer the recorded first stream data corresponding to the updated management information from the first record area to a fifth record area for recording a data different from the first and second stream data on the storage medium.
